(19) United States
(12) Patent Application Publication
(10) Pub. No.: US 2008/0170034 A1
(43) Pub. Date: Jul. 17, 2008

(54) Wireless computer mouse

(75) Inventors: Yung-Chao Lin, Sijhih City (TW); Ya-Chun Pan, Sijhih City (TW); Hung-Chien Huang, Sijhih City (TW)

Correspondence Address: Joe McKinney Muncy, PO Box 1364, Fairfax, VA, 22038-1364, US

(73) Assignee: BEHAVIOR TECH COMPUTER CORP.

(21) Appl. No.: 11/976,697

(22) Filed: Oct. 26, 2007

(30) Foreign Application Priority Data
Jan. 12, 2007 (TW) 96201067

(51) Int. Cl. G06F 3/033

(52) U.S. Cl. 345/158

(57) ABSTRACT

A wireless computer mouse is provided. The wireless computer mouse includes an upper housing having an opening, a press key put around the opening of the upper housing, a containing base coupled to a bottom of the upper housing and for placing the receiver, a lower housing coupled to the base, and a base coupled between the upper housing and the press key as a hinge. By pressing the press key, the upper housing and the lower housing are unfolded such that forms a predetermined angle, and the receiver is flicked from the containing base.

### RELATED APPLICATIONS

This application claims priority to Taiwan Application Serial Number 96201067, filed Jan. 12, 2007, which is herein incorporated by reference.

### BACKGROUND

1. Field of Invention

The present invention relates to a wireless computer mouse. More particularly, the present invention relates to a wireless computer mouse wherein an upper housing and a lower housing are able to be unfolded for placing and retrieving a receiver and for changing a battery.

2. Description of Related Art

Please refer to FIG. 1 and FIG. 2. A wireless computer mouse disclosed in TW utility model Patent NO. 093208781, entitled “Wireless Input Device”, is illustrated in FIG. 1 and FIG. 2. The wireless computer mouse includes a main body 310, a outer cover 320 capable of separating from and covering up to the main body 310, and a press key 330. A containing slot 312 is installed on the main body 310 for containing the receiver 340. A second containing space 315a and a third containing space 315b are located at two sides of a containing space 319 of the main body 310 for containing batteries. Holes 317 are at two sides of the containing slot 312. Stems 351 and stubs 352 are installed on a fragment 350, the stems 351 stretching into holes 317.

An elastic component 318 is installed in the positioning section 311, resisting a joint 341 of the receiver 340. A hinge 316 is located on the positioning section 311, fastened with a spindle 331 of the press key 330 such that the press key 330 may seesaw. An elastic key 313 is formed at each of two sides of the positioning section 311. There are prominent points 314 on the elastic keys 313, prominent point 314 for lodging in fillisters 342 of the receiver 340.

A hook 321 and an opening 322 are located at a front side and a back side of the outer cover 320, respectively. The hook 321 buckles the prominent point 314 on the elastic key 313, and the opening 322 is corresponding to the first containing space 319 of the containing slot 312.

By pressing a front half portion of the press key 330, the pressure changes the shape of the fragment 350 via the stem 351, such that separates the stub 352 and fillister 342. Further, the receiver 340 is bounced out from the first containing space 319 by the elasticity provided by the elastic component 318.

By pressing a back half portion of the press key 330, the pressure changes the shape of the elastic key 313, such that separates the prominent point 314 and the hook 321. The outer cover 320 is further pushed out and separates from the main body 310. The outer cover 320 is opened then.

By the forgoing description, it is observed that, in the conventional wireless computer mouse, though the receiver and the battery can be contained in the main body, the outer cover and the main body totally separate from each other. When placing the conventional wireless computer mouse in a bag, e.g. a travel bag, press key 330 of the conventional wireless computer mouse may be compressed by other articles with the bag, or collide with things outside the bag. Therefore, the back half portion of the press key 330 may be pressed such that separates the outer cover 320. The separated outer cover 320 is easily broken. Meanwhile, the internal components of the main body 310 are exposed, easily to be broken.

### SUMMARY

It is therefore an aspect of the present invention to provide a wireless computer mouse that is able to contain a receiver therein.

It is another aspect of the present invention to provide a wireless computer mouse that solves the drawback of the outer cover being easily dropped from the main body by collision due the totally-separation between the main body and the outer cover. Further, the disadvantage that the internal components of the main body are exposed in accordance and become easily broken is relieved.

In accordance with the foregoing and other aspects of the present invention, a wireless computer mouse is provided that includes an upper housing having an opening, a press key put around the opening of the upper housing, a containing base coupled to a bottom of the upper housing and for placing the receiver, a lower housing coupled to the base, and a base coupled between the upper housing and the press key as a hinge. By pressing the press key, the upper housing and the lower housing are unfolded such that forms a predetermined angle. And the receiver is flicked from the containing base in accordance.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a portion of this specification. The drawings illustrate embodiments of the invention and, together with the description, serve to explain the principles of the invention. In the drawings,

FIG. 1 is an explosion diagram of a conventional wireless computer mouse;

FIG. 2 is a bottom view of a press key in the prior art;

FIG. 3 is an explosion diagram of a wireless computer mouse according to the present invention;

FIGS. 4A, 4B and 4C are explosion diagrams of portions of a wireless computer mouse according to the present invention;

FIG. 5A is a bottom view of an upper cover and an upper housing of a wireless computer mouse according to the present invention;

FIG. 5B is a bottom view of press key, a containing base and a battery cover of a wireless computer mouse according to the present invention;

FIG. 6 is a diagram of a present receiver not inserting in a containing base of a wireless computer mouse according to the present invention;

FIG. 7 is a sectional view of the receiver in FIG. 6;

FIG. 8 is a motion diagram of a present receiver inserting in a containing base of a wireless computer mouse according to the present invention;

FIG. 9 is a bottom view of the receiver in FIG. 8;

FIG. 10 is a sectional diagram of an upper housing coupling to a lower housing of a wireless computer mouse according to the present invention; and

FIG. 11 is a diagram of an upper housing, a lower housing, a containing base and a receiver of a wireless computer mouse according to the present invention.

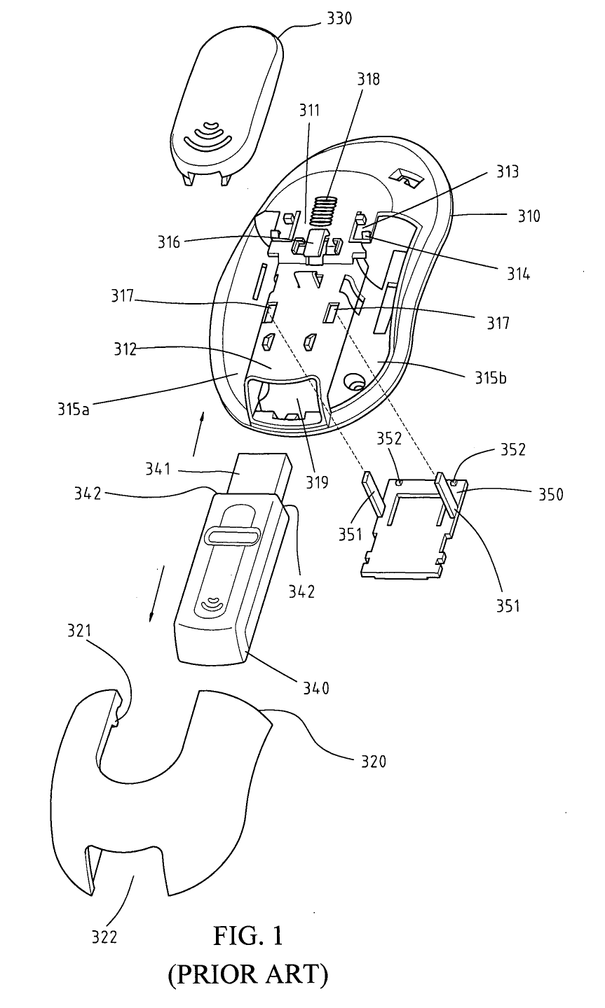

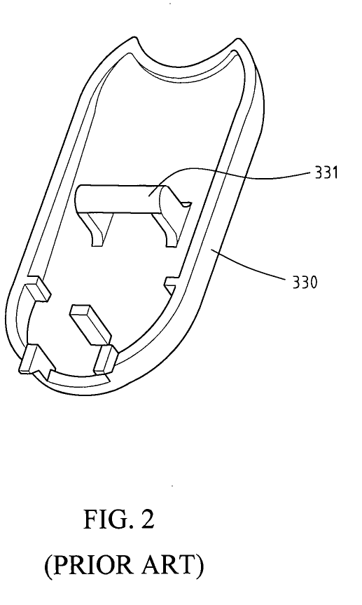

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

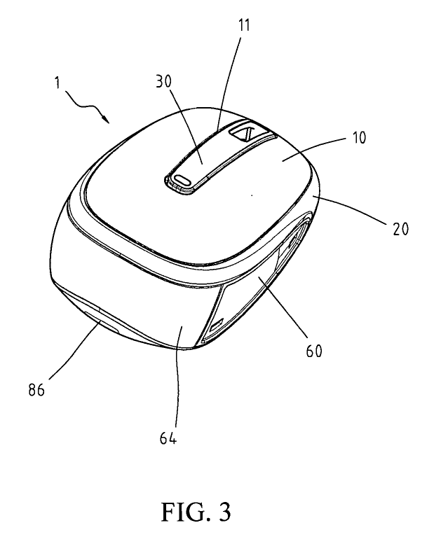

Please refer to FIGS. 3, 4A-4C, and 5A-5B. The present wireless computer mouse 1 includes an upper cover 10, an upper housing 20, a press key 30, a containing base 40, a receiver 50, a lower housing 60, a circuit board 70, and a base 80. Details of these components are described as follows.

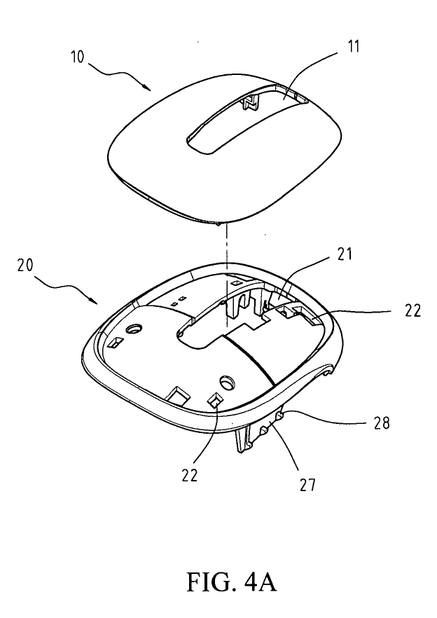

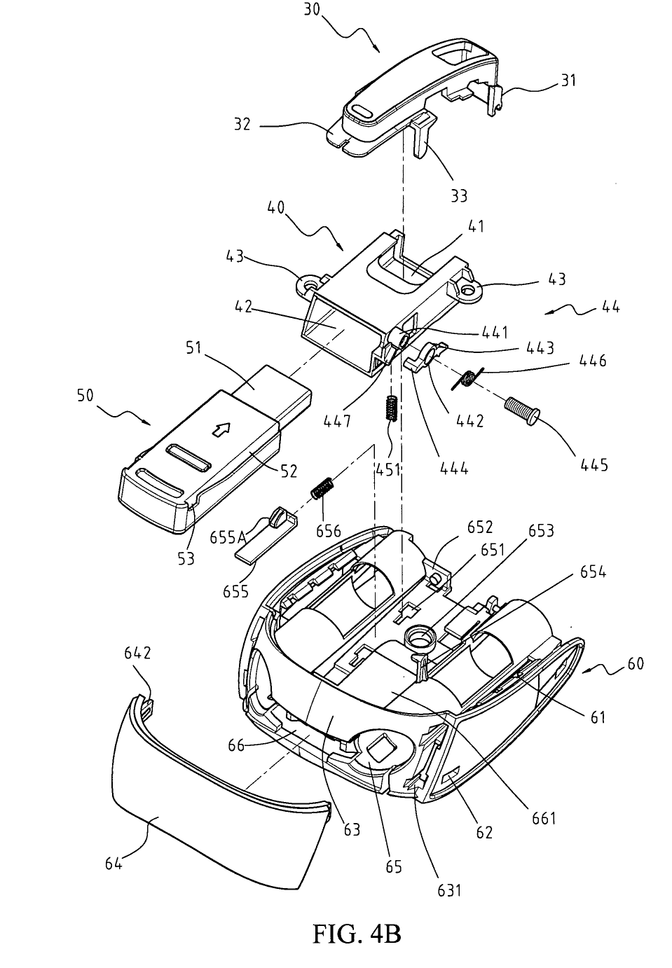

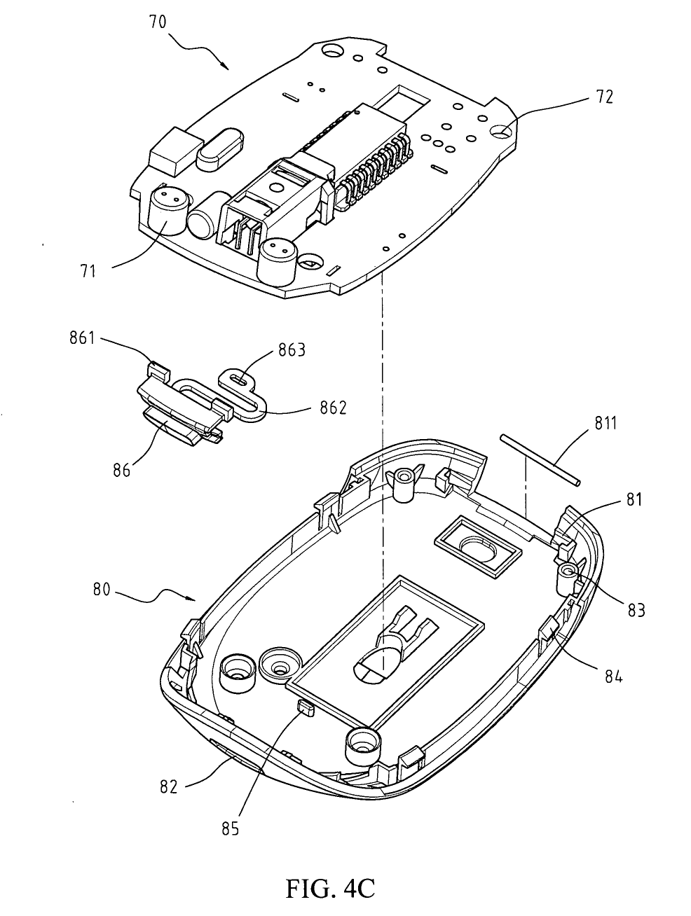

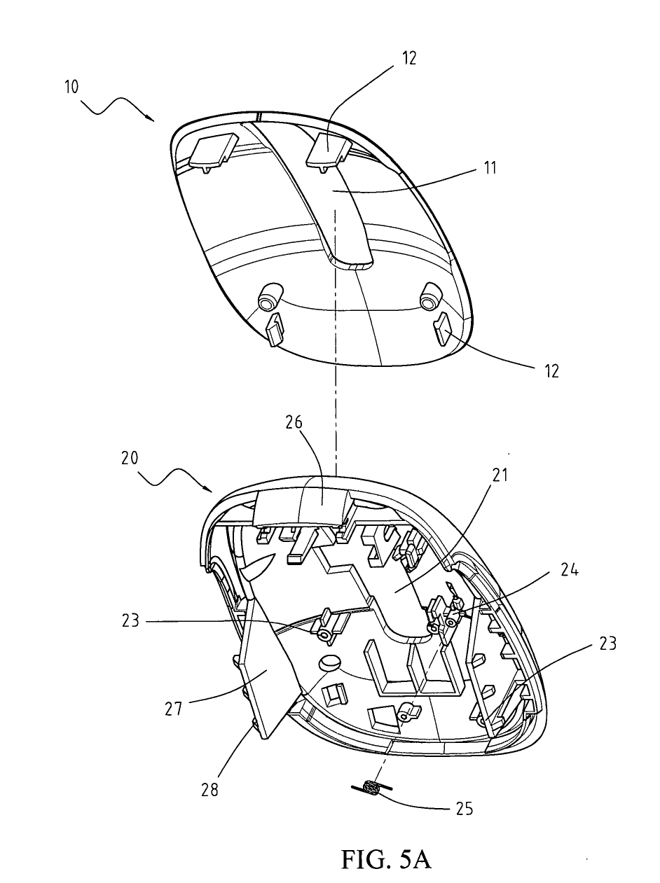

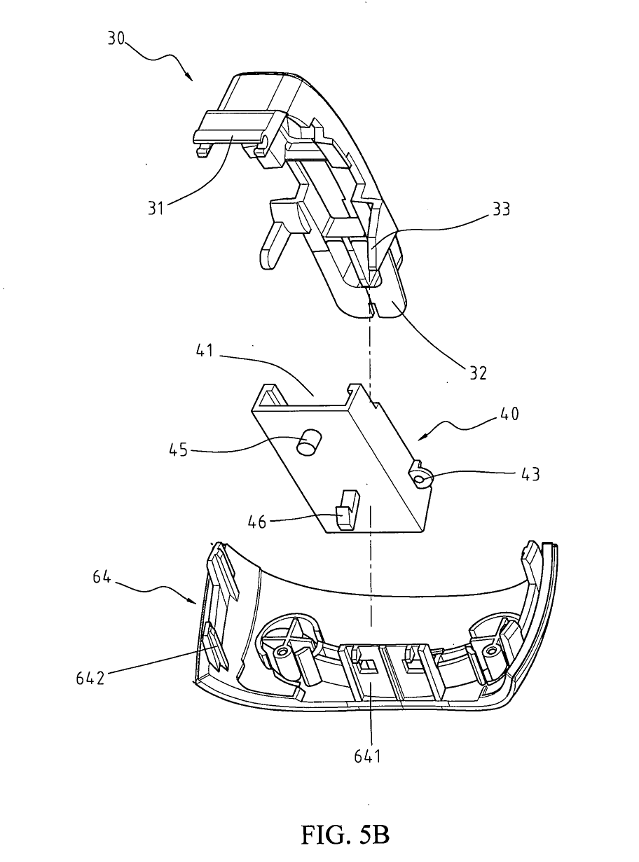

Please refer to FIGS. 4A and 5A. There are an opening 11 on the upper cover 10, and four fasteners 12 at a bottom of the upper cover 10.

Please refer to FIGS. 4A and 5A. There is an opening 21 on the upper housing 20. The opening 21 is corresponding to the opening 11. There is a plurality of perforations 22 on the upper housing 20. There are a plurality of positioning holes 23 and a stub 24 on the bottom of the upper housing 20, wherein the stub 24 is linked with a second torsion spring 25. A hinge 26 is installed at the back end of the upper housing 20, and a side plate 27 is installed at each of the left side and the right side of the upper housing 20. A plurality of hooks 28 are formed at the edge of each side plate 27.

Please refer to FIGS. 4B and 5B. There are a hinge 31 installed at the back end of the press key 30, and a board 32 installed at the front end of the press key 30, and vertical portions 33 at the two sides.

Referring to FIGS. 4B and 5B, there are a second opening 42 and a first opening 41 at the front end and the back end of the containing base 40, respectively, and positioning holes 43 at the left side and the right side of the containing base 40. There is a shaft 45 having a first spring 451 installed on the bottom of the containing base 40.

Please refer to FIG. 4B. A carrier 44 is installed at a side of the containing base 40. The carrier 44 includes a spindle 441 installed at a side of the containing base 40, a tube 442 set around the spindle 441 having a vertical shaft 443 and a transverse shaft 444 as two ends. The carrier 44 may be locked to the spindle 441 via the screw 445, such that positions the tube 442 to the spindle 441. The first torsion spring 446 is in accordance coupled between the screw 445 and the tube 442 such that the tube 442 may rotate around the spindle 441, and the tube 442 may return back to the initial position after the rotation. The carrier 44 further includes a slanting surface 447 installed at a side of the containing base 40 and near the spindle 441. The transverse shaft 444 may then move to above the slanting surface 447.

Please refer to FIG. 4B. There are two through-holes 651, a positioning board 652 and an indentation 653 installed between the two battery containing spaces 65. A first hook 654 is installed on a top of one of the battery containing spaces 65, e.g. the right battery containing space 65. There are two through-holes 651 put around the movable slide 655. The movable slide 655 has a slope 655A on its upper side. The second spring 656 is put around between the movable slide 655 and the positioning board 652 for providing elasticity for repositioning the movable slide 655.

Referring to FIG. 4B, there are a joint 51 set on the receiver 50, and at least a fillister 52 located on at least one side, e.g. the left side or the right side, of the receiver 50. An indentation 53 is set at the end of the fillister 52.

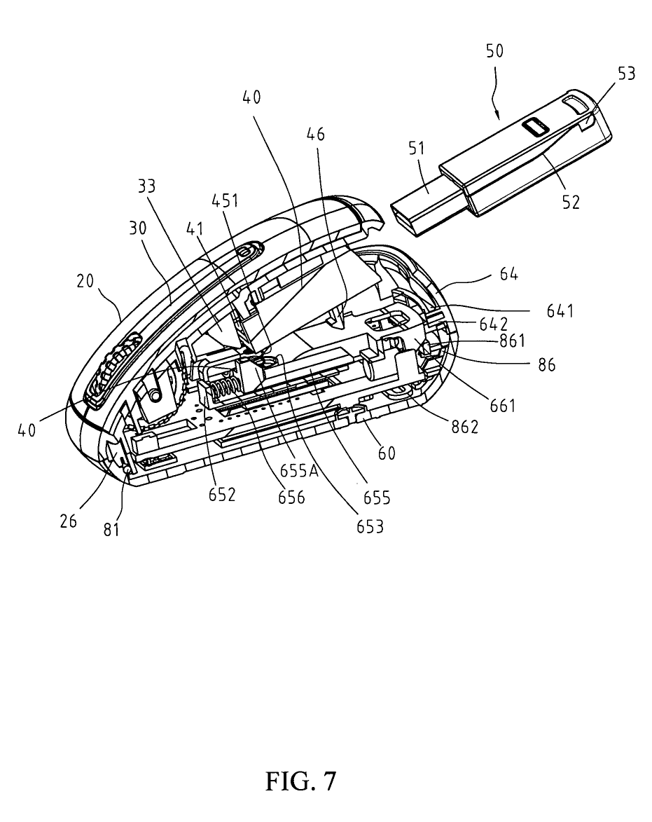

Please refer to FIG. 4C. A placing portion 61 and a fastener 62 are installed at the left side and the right side of the lower housing 60, respectively, and an opening 63 is set at the front end of the lower housing 60, wherein the front end is able to be covered up to the battery cover 64. Indentations 631 are located at the left end and the right end of the opening 63. A notch 66 is formed in the center of the opening 63. Referring to FIG. 7, an upper slope 661 is installed on the upper half portion of the notch 66, and the left side and the right side of the notch 66 are next to the battery containing spaces 65.

Please refer to FIGS. 4B and 5B. The lifter includes a first spring 451, a positioning board 452, a movable slide 655, a second spring 656 and a second hook 46. The second hook 46 is installed at the bottom of the containing base 40.

Please refer to FIG. 4C. A plurality of circuit components 71 and a plurality of positioning holes 72 are installed on a circuit board 70.

Referring to FIG. 4C, a hinge 81 and a withdrawing key hole 82 are set at the back end and the front end of the base 80, respectively. Positioning holes 83 and fasteners 84 are installed at the left side and the right side of the base 80. A shaft 811 is set around the hinge 81. A prominent point 85 is set behind the withdrawing key hole 82.

Referring to FIG. 4C, a protruding piece 861 is installed on the withdrawing key 86. An elastic portion 862, having a hole 863, stretches from the back end of the withdrawing key 86.

Please refer to FIG. 5B. A battery cover 64 and a stub 642 are installed at the lower slope 641.

Please refer to FIGS. 4, 5 and 6. When fabricating the present wireless computer mouse 1, the withdrawing key 86 is first placed into the withdrawing key hole 82 at the front end of the base 80, and the hole 863 of the elastic portion 862 is put around the prominent point 85, such that positions the withdrawing key 86 at the base 80. Next, the circuit board 70 is placed on the base 80, and the plurality of positioning holes 72 of the circuit board 70 are aligned to the plurality of positioning holes 83 of the base 80, separately. These positioning holes 72 and 83 are then screwed (not shown) to lock to each other, such that fixes the circuit board 70 to the base 80. Afterwards, the plurality of fasteners 62 of the lower housing 60 are locked to the plurality of fasteners 84 of the base 80, such that fixes the lower housing 60 to the base 80. In accordance, the upper slope 661 located within the notch 66 resists the protruding piece 861 of the withdrawing key 86.

After that, the stubs 642 of the battery cover 64 are fastened to the indentations 631 at the opening 63 of the lower housing 60, separately. Meanwhile, the upper slope 661 is fastened within the notch 66 by the lower slope 641 of the battery cover 64. Therefore, the battery cover 64 is assembled, covering up the opening 63 of the lower housing 60 opening 63.

Next, the fasteners 12 of the upper cover 10 lock the perforations 22 installed on the upper housing 20. And the opening 11 of the upper cover 10 is aligned to the opening 21 of the upper housing 20, such that fixes the upper cover 10 to the upper housing 20.

In the following, the press key 30 is placed into the opening 21 of the upper housing 20 and the opening 11 of the upper cover 10, and the board 32 is aligned to the bottom of the upper housing 20. Further, the hinge 31 is assembled with the hinge 26 of the upper housing 20.

Next, the plurality of positioning holes 43 of the containing base 40 are aligned to the plurality of positioning holes 23 of the bottom of the upper housing 20. The positioning holes 43 and the positioning holes 23 are further screwed (not shown) to lock to each other, such that fixes the containing base 40 to the upper housing 20.

Therefore, the press key 30 is linked between the upper housing 20 and the containing base 40, and an end of the second torsion spring 25 is located within the first opening 41 of the containing base 40. Further, the second torsion spring 25 is fixed at the stub 24 of the upper housing 20. Hence the assembly of the upper cover 10, the upper housing 20, the press key 30 and the containing base 40 is implemented.

In the following, a shaft 811 is utilized to fasten the hinge 26 of the upper housing 20 and the hinge 31 of the press key 30 to the hinge 81 of the base 80.

Next, the two side plates 27 of the upper housing 20 are placed into the two placing portions 61 of the lower housing 60. A hook 28 at the edge of each side plate 27 hooks the upper edge of each placing portion 61, such that the upper housing 20 and the base 80, lower housing 60 may be assembled together. The first hook 654 of the lower housing 60 may be located above the vertical shaft 443. When the upper housing 20 is lifted up from the lower housing 60 with the shaft 811 as an axle, the upper housing 20 and the lower housing 60 are unfolded to form a predetermined angle. Thereby, the present wireless computer mouse 1 is fabricated.

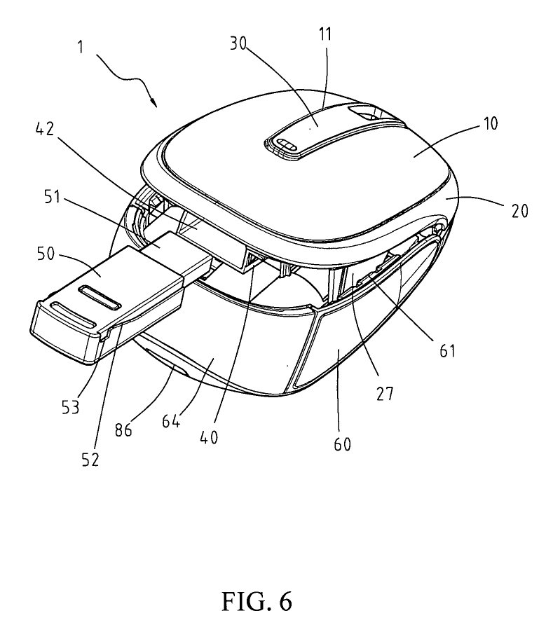

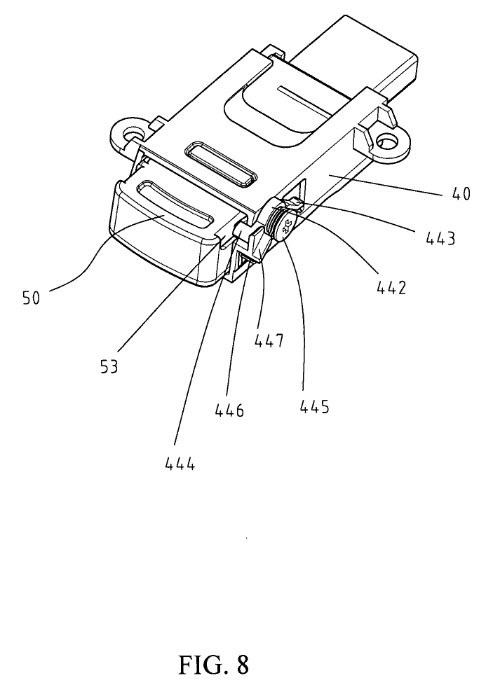

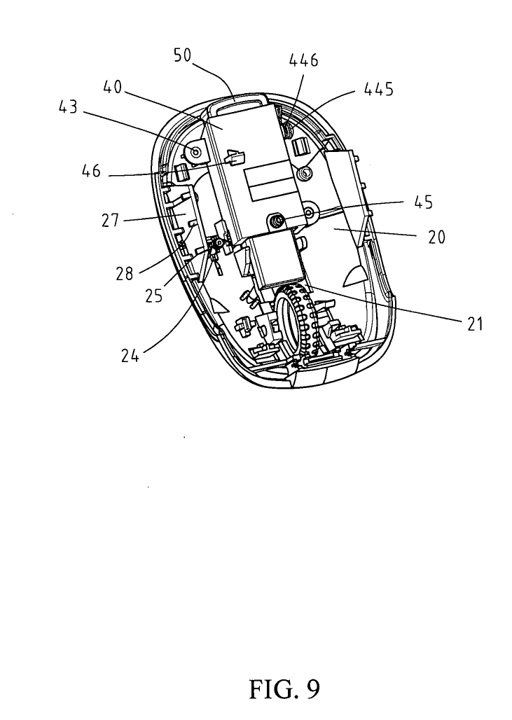

The storing of the receiver 50 is described as follows. Please refer to FIGS. 6, 7 and 9. For storing the receiver 50 within the wireless computer mouse 1, the receiver 50 is first placed into the containing base 40 through the second opening 42. The front end of the receiver 50 hence resists the second torsion spring 25, and the joint 51 of the receiver 50 stretches out from the first opening 41. Please refer to FIG. 8. By slowly and smoothly placing the receiver 50 into the containing base 40, the fillister 52 at the side of the receiver 50 moves along the transverse shaft 444 of the containing base 40. When the receiver 50 is completely placed in the containing base 40, the transverse shaft 444 of the containing base 40 fastens the indentation 53 of the receiver 50, such that the receiver 50 is completely stored within the containing base 40.

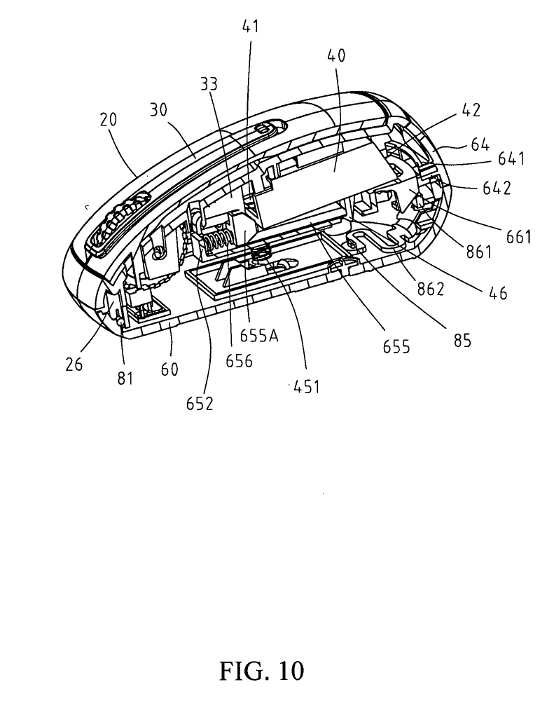

Please refer to FIGS. 7 and 10. The upper housing 20 may be pressed down smoothly and slowly. The two side plates 27 of the upper housing 20 may move downward and toward the placing portion 61 of the lower housing 60. Meanwhile, the upper housing 20 pushes the containing base 40 forward to move downward together. When the upper housing 20 covers up the lower housing 60, the first spring 451 is pressed to the indentation 653 of the lower housing 60, the second hook 46 hooks the movable slide 655, and the vertical portion 33 of the press key 30 may be right next to the slope 655A of the movable slide 655.

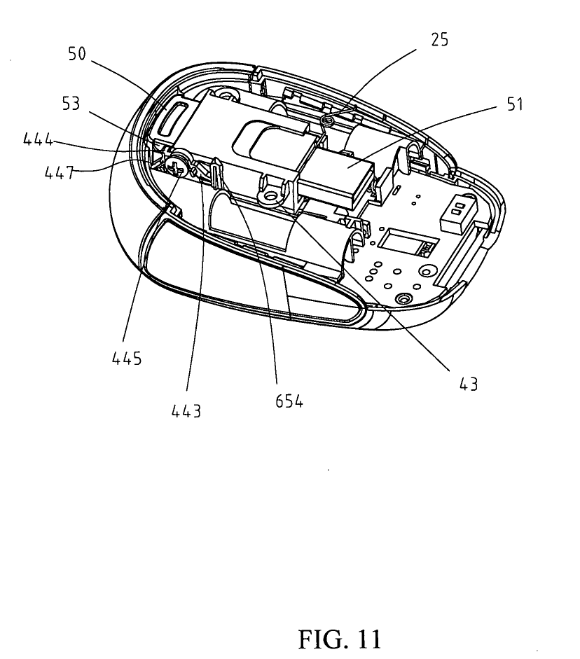

Details of retrieving the receiver 50 are described as follows. Please refer to FIGS. 3, 10 and 11. For taking out the receiver 50 from the containing base 40 of the wireless computer mouse 1, the press key 30 is pressed down slowly first. The vertical portion 33 of the press key 30 may move downward slowly such that presses the slope 655A of the movable slide 655. The movable slide 655 is moved accordingly, and the moving range of the movable slide 655 is limited within the two through-holes 651 of the lower housing 60. The movable slide 655 in motion presses the second spring 656, such that the second hook 46 of the containing base 40 is unhooked and departs from the movable slide 655. Further, the first spring 451 bounces upward, such that pushes upward the upper housing 20, the containing base 40 and the upper cover 10, which are assembled together. Meanwhile, the two side plates 26 leave the placing portion 61. Since the hooks 27 of the two side plates 26 moved upward eventually hook the upper edge of the placing portion 61, the upper housing 20, the containing base 40 and the upper cover 10, which are assembled together, imay lift up from the lower housing 60 with the shaft 811 as an axel, such that forms a predetermined angle.

In the process of unfolding, the first hook 654 of the lower housing 60 touches and presses the top of the vertical shaft 443 of the containing base 40. The vertical shaft 433 is pushed to move downward taking the tube 442 as a center. Simultaneously, a transverse shaft 444 located at another side of the tube 442 is pushed forward as well. The transverse shaft 444 takes the tube 442 as a center and moves upward. Hence, the transverse shaft 444 leaves the indentation 53 of the receiver 50 gradually. When the transverse shaft 444 completely leaves the indentation 53 of the receiver 50, the receiver 50 is pushed outward by the second torsion spring 25 that resists the receiver 50. Therefore, a part of the receiver 50 is exposed outside the containing base 40. Hence the retrieving of the receiver 50 is implemented.

Details of the process of replacing batteries are described below. Please refer to FIGS. 3, 5B and 7. For replacing batteries (not shown) in the present wireless computer mouse 1, the withdrawing key 86 below the base 80 is pressed first. The upper slope 661 is pushed upward by the protruding piece 861 of the withdrawing key 86, such that a slot is generated between the upper slope 661 and the lower slope 641. Hence the upper slope 661 and the lower slope 641 depart from each other. Next, the battery cover 64 is pulled outward to reject from the lower housing 60. A new battery may be placed into the battery containing space 65 thereafter.

In the present invention, the unfolding of the upper housing and the lower housing, and the placing and rejecting of the receiver, are implemented by the lifter and the carrier. Therefore, the utilization of the present wireless computer mouse becomes more convenient. Further, the drawbacks of the conventional wireless computer mouse described above are improved.

Although the present invention has been described in considerable detail with reference to certain preferred embodiments thereof, other embodiments are possible. For example, the numbers of the aforementioned magnetic units and assistant aligning structures are not limited to the present embodiments, and may be arranged and designed in various ways for different requirements. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless computer mouse, comprising:
an upper housing, comprising an opening;
a press key, installed within the opening of the upper housing;
a containing base, coupled to a bottom of the upper housing for containing a receiver;
a base, coupled to the upper housing and the press key; and
a lower housing, pivotally coupled to the base;
wherein the upper housing and the lower housing are unfolded by pressing the press key such that a predetermined angle is formed to flick out the receiver from the containing base accordingly.

2. The wireless computer mouse of claim 1, further comprising:
an upper cover, comprising an opening aligned corresponding to the opening of the upper housing; and
a plurality of fasteners, installed at the bottom of the upper cover.

3. The wireless computer mouse of claim 1, wherein the upper housing further comprising a stub for coupling to a second torsion spring, wherein the second torsion spring is utilized to flick out the receiver.

4. The wireless computer mouse of claim 1, wherein a fillister is set at a side of the receiver, and an indentation is set at an end of the fillister.

5. The wireless computer mouse of claim 1, further comprising a carrier utilized to carry the receiver in the containing base.

6. The wireless computer mouse of claim 5, wherein the carrier comprises:
a spindle, installed at a side of the containing base;
a tube, put around the spindle, wherein two ends of the tube extend to a transverse shaft and a vertical shaft separately, and the tube can move along the spindle;
a screw, for fixing the tube around the spindle;
a first torsion spring, installed between the screw and the tube; and
a slanting surface, installed at a side of the containing base and near the spindle.

7. The wireless computer mouse of claim 1, further comprising a lifter, wherein the lifter is triggered to unfold the upper housing and the lower housing when the press key is pressed.

8. The wireless computer mouse of claim 7, wherein the lifter comprises:
a first spring, coupled between the bottom of the containing base and the lower housing;
a movable slide, fastened to the lower housing, wherein a slope is set on the movable slide and in touch with a vertical portion of the press key, and the slope is pushed by the vertical portion so as to move the movable slide;
a positioning board, installed on the lower housing and facing toward the movable slide;
a second spring, installed between a front end of the movable slide and the positioning board; and
a second hook, installed at the bottom of the containing base and hooked with the movable slide;
wherein by pressing the vertical portion of the press key to move forward the slope, the movable slide is moved to push the second spring, such that the second hook is unhooked from the movable slide, and the first spring pushes the containing base upward so as to unfold the upper housing and the lower housing to form a predetermined angle.

9. The wireless computer mouse of claim 1, further comprising a circuit board fixed between the lower housing and the base.

10. The wireless computer mouse of claim 1, further comprising a battery cover having a lower slope and a stub.

11. The wireless computer mouse of claim 1, wherein the lower housing comprises:
an opening;
a plurality of indentation, located at a left end and a right end of the opening;
a notch, located in a center of the opening; and
an upper slope, located at an upper half portion of the notch;
wherein a left end or a right end of the notch is next to a space for containing a battery separately, wherein the stub and the lower slope are fastened to the notch and the upper slope respectively, such that the battery cover covers the opening.

12. The wireless computer mouse of claim 11, wherein two side plates are installed on the upper housing, and each of the side plates includes a plurality of hook portions.

13. The wireless computer mouse of claim 12, wherein two placing portions are installed in the lower housing, and the placing portions are utilized to place the side plates.

14. The wireless computer mouse of claim 13, wherein the hook portions of the side plates are hooked to an upper edge of the placing portion so as to unfold the upper housing and the lower housing to form a predetermined angle.

15. The wireless computer mouse of claim 10, further comprising a withdrawing key, utilized to cover up the battery cover and the lower housing or withdraw the battery cover from the lower housing.

16. The wireless computer mouse of claim 15, wherein the withdrawing key comprises a prominence and an elastic portion, wherein the elastic portion comprises a hole.

17. The wireless computer mouse of claim 16, wherein a plurality of fasteners, a hole for the withdrawing key and a prominent point are installed on the base; wherein a fastener is installed on the lower housing for fastening the plurality of fasteners of the base so as to couple the lower housing and the base.
